(19) United States
(12) Patent Application Publication
(10) Pub. No.: US 2017/0190604 A1
(43) Pub. Date: Jul. 6, 2017

(54) USE OF MAGNESIUM HYDROXIDE IN THE NEUTRALIZATION OF PTA WASTEWATER

(71) Applicant: BP Corporation North America Inc., Naperville, IL (US)

(72) Inventor: Mamtu Chandnani, Naperville, IL (US)

(73) Assignee: BP Corporation North America Inc., Houston, TX (US)

(21) Appl. No.: 15/392,063

(22) Filed: Dec. 28, 2016

Related U.S. Application Data
(60) Provisional application No. 62/273,507, filed on Dec. 31, 2015.

(51) Int. Cl. C02F 9/00; C02F 3/28; C02F 1/00; C02F 1/66

(52) U.S. Cl. CPC C02F 9/00; C02F 1/66; C02F 3/28; C02F 1/008; C02F 2101/34

(57) ABSTRACT

Processes and apparatuses for the neutralization of wastewater comprising terephthalic acid are provided. Such processes and apparatuses use magnesium hydroxide to neutralize the wastewater upstream of an anaerobic reactor.

### CROSS-REFERENCE TO RELATED APPLICATION

This Application claims the benefit of U.S. Provisional Application No. 62/273,507, filed on Dec. 31, 2015, which is hereby incorporated herein by reference in tis entirety for all purposes.

### FIELD

The present invention relates to processes and apparatuses for the neutralization of wastewater containing terephthalic acid, and in particular, including the use of magnesium hydroxide to neutralize the wastewater.

### BACKGROUND

Paraxylene is used to make purified terephthalic acid (“PTA”). Paraxylene is oxidized in the presence of a catalyst and an acetic acid solvent to make crude terephthalic acid. The crude terephthalic acid is then hydrogenated to make PTA. These two reactions are generally described in U.S. Pat. No. 5,723,656. Typically, wastewater comprising organic materials (terephthalic acid, acetic acid, para-toluic acid) is neutralized by mixing the wastewater with a solution of diluted sodium hydroxide. The mixing/neutralization occurs upstream of an anaerobic reactor in order to ensure that the wastewater is at the proper pH for the degradation of the terephthalic acid and other organic materials into methane, carbon dioxide, and water.

If too much sodium hydroxide is used, however, the pH of the wastewater entering the anaerobic reactor will be too high, which causes loss of activity in the anaerobic biomass and thus loss of degradation of organic compounds in the wastewater. Recovery of anaerobic reactor efficiency can take months and biomass granules may have to be replaced.

### SUMMARY

The present invention allows for greater control of the pH of the wastewater and thus the preservation of the activity in anaerobic biomass.

In one aspect, a process is provided for treating wastewater comprising terephthalic acid. The process comprises mixing magnesium hydroxide with wastewater comprising terephthalic acid in a mixing vessel to produce a neutralized wastewater effluent and removing organic material from the neutralized wastewater effluent in an anaerobic reactor.

In another aspect, an apparatus for treating wastewater comprising terephthalic acid is provided. The apparatus comprises a source of wastewater comprising terephthalic acid, a source of magnesium hydroxide, a mixing vessel in fluid communication with the source of wastewater and the source of magnesium hydroxide, the mixing vessel adapted to mix the wastewater and the magnesium hydroxide to form a neutralized wastewater effluent, and an anaerobic reactor in fluid communication with the mixing zone, the anaerobic reactor comprising granules adapted remove organic material from the neutralized wastewater effluent.

### BRIEF DESCRIPTION OF THE DRAWINGS

FIG. 1 is an apparatus for neutralizing wastewater comprising terephthalic acid using magnesium hydroxide; and

FIG. 2 is an alternative embodiment of an apparatus for neutralizing wastewater comprising terephthalic acid using magnesium hydroxide.

### DETAILED DESCRIPTION

Magnesium hydroxide is a much weaker base than sodium hydroxide. Thus, using magnesium hydroxide as a pH control agent instead of sodium hydroxide minimizes pH spikes in the event of an inadvertent overdose of the pH control agent. High doses of magnesium hydroxide in wastewater comprising terephthalic acid result in a maximum pH of 9.0 compared to high doses of sodium hydroxide, which result in a pH of up to 14.0. In addition, when magnesium hydroxide is used, recovery of biomass activity in an UASB reactor and the ability to degrade terephthalic acid is much quicker. For example, when using magnesium hydroxide recovery occurs in about three weeks compared to six to seven weeks when sodium hydroxide is use (plus permanent loss of the capability to degrade para-toluic acid). Magnesium hydroxide acts a nutrient for anaerobic and aerobic systems, resulting in denser sludge in the clarifiers (the longer reaction time is conductive to crystal growth), cleaner water discharged, and sludge that is easier to dewater for disposal. Furthermore, because magnesium hydroxide has about 37 percent more hydroxide than sodium hydroxide, less magnesium hydroxide is required to neutralize a given amount of terephthalic acid. Magnesium hydroxide is also non-hazardous by DOT standards. Moreover, unlike sodium hydroxide, magnesium hydroxide is non-corrosive, resulting in reduction in maintenance repair costs of valves, pipes, pumps, and storage tanks.

However, magnesium hydroxide takes longer to neutralize the terephthalic acid than sodium hydroxide. Thus, a separate mixing vessel is required in order to allow about 20 minutes of residence time. Furthermore, because magnesium hydroxide is a slurry, the mixing vessel requires an agitator.

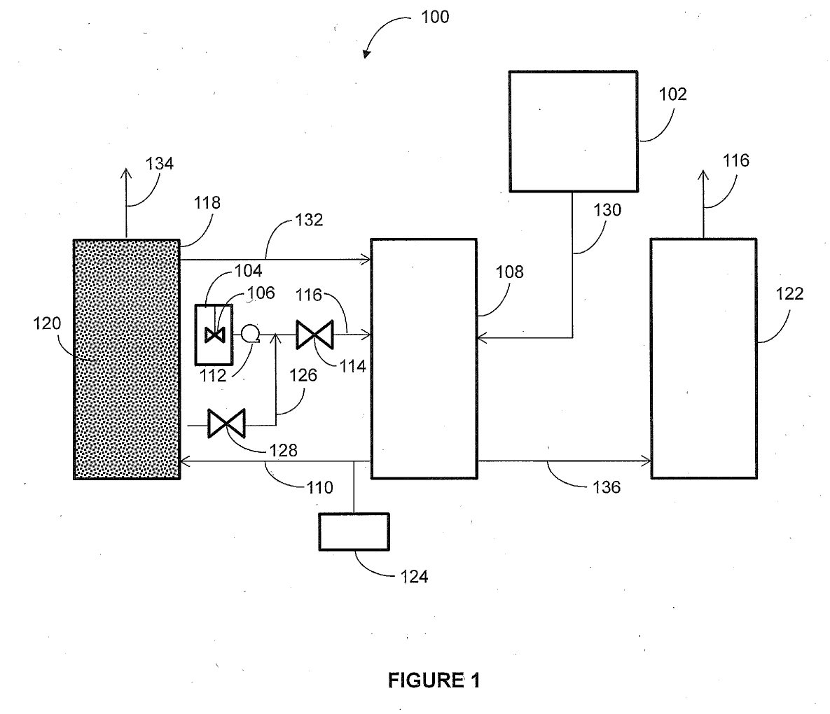

FIG. 1 illustrates an apparatus 100 for treating wastewater comprising terephthalic acid. The apparatus 100 comprises a source of wastewater comprising terephthalic acid, such as a process for making terephthalic acid 102 and a source of magnesium hydroxide, such as a tank 104 containing magnesium hydroxide and having an agitator 106 adapted to maintain the magnesium hydroxide in a slurry. One suitable system for making terephthalic acid is shown, for example, in U.S. Pat. No. 5,723,656. The agitator may be a low revolutions per minute agitator, which keeps the slurry suspended in the tank 104. The apparatus 100 also comprises a mixing vessel 108, which is in fluid communication with the source of wastewater comprising terephthalic acid 102 and the source of magnesium hydroxide 104. The mixing vessel 108 is adapted to mix the wastewater and the magnesium hydroxide to form a neutralized wastewater effluent 110. The apparatus 100 may also include a pump mechanism 112 adapted to pump magnesium hydroxide out of the tank 104, through a valve 114 in an inlet line 116, and into the mixing vessel 108.

The apparatus 100 further comprises an anaerobic reactor 118 in fluid communication with the mixing vessel 104. The anaerobic reactor 118 may include granules 120 which are adapted to remove organic material from the neutralized wastewater effluent stream 110. The anaerobic reactor may be, for example, an upflow anaerobic sludge blanket (“UASB”). Examples of organic material removed include terephthalic acid, acetic acid, and para-toluic acid.

The apparatus 100 may also comprise an aeration system 122 in fluid communication with the anaerobic reactor 118. In other embodiments, the aeration system 122 may be in fluid communication with the mixing vessel 108. The aeration system 122 may be adapted to remove organic material from an effluent from the anaerobic reactor.

The apparatus 100 may further comprise a pH probe 124 configured to measure the pH of the neutralized wastewater effluent, and a dosing control mechanism adapted to control the amount of magnesium hydroxide introduced into the mixing vessel 108 based upon the measured pH. The apparatus 100 may also comprise a flushing mechanism adapted to flush the inlet line with water to remove magnesium hydroxide therefrom. The flushing mechanism may comprise a water line 126 and a flushing valve 128.

A process for treating wastewater comprising terephthalic acid is also provided. Wastewater comprising terephthalic acid is introduced into the mixing vessel 108 through wastewater stream 130. The wastewater stream may comprise about 650 ppm terephthalic acid. Magnesium hydroxide is introduced into the mixing vessel 108 from the tank 104, through the inlet line 116. Magnesium hydroxide and the wastewater comprising terephthalic acid are mixed in the mixing vessel 108 for a period of time to produce the neutralized wastewater effluent stream 110. In example embodiments, magnesium hydroxide and the wastewater are mixed for at least 20 minutes. The neutralized wastewater effluent stream 110 is then introduced to the anaerobic reactor 118.

The pH of the neutralized wastewater stream 110 may be measured using pH probe 124. If the pH is less than a set point, additional magnesium hydroxide may be added through inlet line 116. If the pH is greater than a set point, the valve 114 in the inlet line 116 closes such that no magnesium hydroxide flows through inlet line 116. When the pH is greater than a set point, inlet line 116 may also be flushed with water through to remove any residual magnesium hydroxide and to prevent buildup of magnesium hydroxide in the inlet line 116. For example, when the pH is greater than a set point, valve 114 closes and flushing valve 128 opens, allowing water to flow through water line 126 through the inlet line 116 to the tank 104. Diameters of the pipes in the water line 126 and the inlet line 116 should allow for flow velocities of about 2 feet/second or more in order to prevent the magnesium hydroxide slurry from clogging the inlet line 116.

The anaerobic reactor produces a reactor effluent 132 and a biogas effluent 134. The reactor effluent 132 from the anaerobic reactor 118 is substantially free of terephthalic acid. Reactor effluent 132 may be returned to the mixing vessel 108, where it is further mixed with magnesium hydroxide to produce a second neutralized wastewater effluent stream 136. The second neutralized wastewater effluent stream 136 may be introduced to an aeration system 122. The aeration system 122 is adapted to remove remaining organic materials from the second neutralized wastewater effluent stream 136.

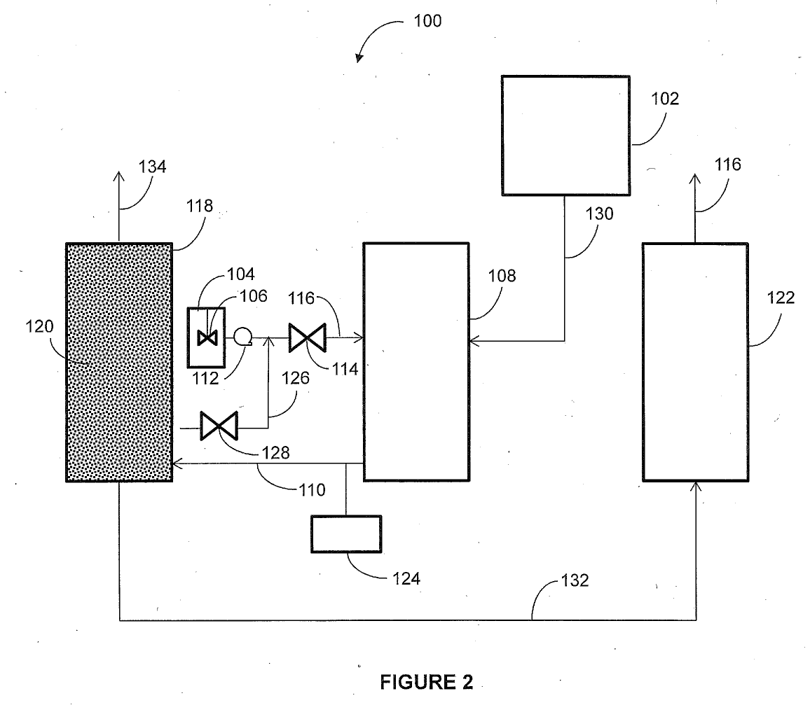

In other embodiments, reactor effluent 132 may be directly introduced to the aeration system 122, as shown in FIG. 2.

Mixing vessel 108 may be a mixing vessel in a wastewater treatment system. In other embodiments, mixing vessel 108 may be a sump or other collection basin in a process for making purified terephthalic acid, such as process 102. Wastewater comprising terephthalic acid may be mixed with magnesium hydroxide in the mixing vessel, the sump, or both.

### EXAMPLES

The following Examples deteanine the impact of using Mg(OH)₂ versus NaOH to neutralize wastewater comprising terephthalic acid. Initially, NaOH is used as the pH control in a mixing vessel to establish a baseline of NaOH consumption and upflow anaerobic sludge blanket (“UASB reactor”) performance. NaOH is then replaced with Mg(OH)₂ in Example 1.

In Example 2, Mg(OH)₂ is introduced as an injection in a recirculation line instead of in the mixing vessel in order to determine the rate of reaction and pH control of the UASB reactor. In Example 3, Mg(OH)₂ is overfed to simulate a malfunction of the reactor effluent pH probe. The feed mixture composition of a normal total organic carbon (“TOC”) wastewater stream and a high TOC wastewater stream is provided in Table 1 below.

TABLE 1
Feed Mixture Composition

| | Normal Total TOC Feed | High Total TOC Feed |
|---|---|---|
| | (1155 ppm) | (1700 ppm) |
| Terephthalic acid | 650 ppm | 1200 ppm |
| Acetic acid | 580 ppm | 1000 ppm |
| Methanol | 105 ppm | 106 ppm |
| Benzoic acid | 270 ppm | 270 ppm |
| Toluics | 340 ppm | 430 ppm |
| Isophthalic acid | 50 ppm | 50 ppm |
| o-phthalic acid | 20 ppm | 20 ppm |
| Trimellitic acid | 50 ppm | 50 ppm |
| Carboxy benzoic acid | 2 ppm | 2 ppm |
| (4CBA) | | |

### Example 1

A pilot plant mixing vessel is fed with a wastewater feed stream with a target TOC of 1155 ppm. The wastewater feed pH is adjusted with a 61 weight percent Mg(OH)₂ slurry. The amount of Mg(OH)₂ needed to increase the feed pH to 5.2 is about 80-85 grams. This is a reduction of 43-46 percent compared to the 148 grams of NaOH needed for the same feed. At ambient temperature, it takes about 20 minutes for pH to stabilize in the mixing vessel. This time may be reduced if the feed temperature is increased as the rate of neutralization of Mg(OH)₂ increase with temperature. The neutralized wastewater stream from the mixing vessel is then provided to the UASB reactor. pH of the effluent from the UASB reactor is about 6.6. Biogas release is constant and UASB reactor performance is also maintained at greater than 99 percent conversion of organic materials, with a slight gain in para-toluic acid conversion.

### Example 2

In order to determine the reaction kinetics of Mg(OH)₂ during normal and high TOC wastewater feed stream loading, pH of the reactor effluent is controlled using a pH controller and 61 weight percent Mg(OH)₂ slurry is injected into the pilot plant recirculation line. The Mg(OH)₂ slurry is stirred using a magnetic stirrer and covered to minimize evaporation. Initially, the same feed composition as in Example 1 is maintained with feed pH ranging from 4.2 to 4.4. At this pH range, settling of feed terephthalic acid and toluics is observed in the tank. The amount of Mg(OH)₂ is controlled with the pump, wherein the pump is “ON” at a reactor effluent pH of 6.5 and “OFF” at a reactor effluent pH of 6.7. At this setting, the reactor effluent pH ranges from 6.3 to 7.2 and the reactor continues to perform well (i.e., maintain a greater than 99 percent conversion of organic materials).

To minimize pH swings in the reactor effluent, Mg(OH)₂ is diluted by 50 percent to a 30.5 weight percent slurry solution. The dilution reduces the pH range of the reactor effluent to between 6.4 and 7.1. With a 25 percent NaOH injection, the pH swing is from 6.4 to 6.9. Biogas production also corresponds with pH swings with a drop in biogas production due to higher solubility of CO₂ in water at higher pH. Analysis of biogas composition is shown in Table 2 below.

TABLE 2
Biogas Composition

| pH | Methane | CO₂ |
|---|---|---|
| 6.4 | 60% | 40% |
| 7.1 | 81% | 19% |

Next, the UASB reactor is periodically fed with high TOCs and a new feed batch with high terephthalic acid, high acetic acid, and high total TOC of 1700 ppm is introduced to determine the control of effluent pH by Mg(OH)₂ at high TOC loading rates. Reactor TOC conversion is maintained at greater than 99 percent and the consumption of Mg(OH)₂ is 35-40 percent lower than that of NaOH at the same TOC loading rate.

### Example 3

In this Example, the objective is to simulate malfunction of the pH probe, which would result in excess Mg(OH)₂ injection. The Mg(OH)₂ pump is turned on for about 7 hours and 250 grams of Mg(OH)₂ is pumped to the UASB reactor (7 times the daily consumption of Mg(OH)₂ by the UASB reactor). pH peaks at about 8.2 and biogas production drops. Analysis of the feed and effluent TOC indicates a drop in terephthalic acid and toluics conversion, but the remaining organic materials continued to degrade. Total TOC conversion dropped to 55 percent, but recovered within 72 hours to 90 percent conversion. However, conversion of toluics took about 21 days to achieve greater than 90 percent conversion.

The use of Mg(OH)₂ provides a better response compared to overload of NaOH, which results in an effluent pH approaching 14, thus resulting in severe toxicity of the UASB reactor microbial population.

While the invention has been described above according to its preferred embodiments, it can be modified within the spirit and scope of this disclosure. This application is therefore intended to cover any variations, uses, or adaptations of the invention using the general principles disclosed herein. Further, the application is intended to cover such departures from the present disclosure as come within the known or customary practice in the art to which this invention pertains and which fall within the limits of the following claims.

What is claimed is:

1. A process for treating wastewater comprising terephthalic acid, the process comprising:
mixing magnesium hydroxide with wastewater comprising terephthalic acid in a mixing vessel to produce a neutralized wastewater effluent; and
removing organic material from the neutralized wastewater effluent in an anaerobic reactor.

2. The process of claim 1, further comprising pumping the magnesium hydroxide from a magnesium hydroxide tank through an inlet line into the mixing vessel.

3. The process of claim 2, further comprising measuring pH of the neutralized wastewater effluent.

4. The process of claim 3, further comprising adding magnesium hydroxide to the mixing vessel when the measured pH is lower than a set point.

5. The process of claim 4, further comprising flushing the inlet line to remove magnesium hydroxide therefrom when pH is greater than or equal to the set point.

6. The process of claim 1, wherein an effluent from the anaerobic reactor is substantially free of terephthalic acid.

7. The process of claim 1, further comprising returning an effluent from the anaerobic reactor to the mixing vessel.

8. The process of claim 1, further comprising introducing an effluent from the anaerobic reactor to an aeration system.

9. The process of claim 2, wherein the magnesium hydroxide in the tank is in a slurry with a magnesium hydroxide concentration between 50 weight percent and 70 weight percent.

10. An apparatus for treating wastewater comprising terephthalic acid, the apparatus comprising:
a source of wastewater comprising terephthalic acid;
a source of magnesium hydroxide;
a mixing vessel in fluid communication with the source of wastewater and the source of magnesium hydroxide, the mixing vessel adapted to mix the wastewater and the magnesium hydroxide to form a neutralized wastewater effluent; and
an anaerobic reactor in fluid communication with the mixing zone, the anaerobic reactor comprising granules adapted remove organic material from the neutralized wastewater effluent

11. The apparatus of claim 10, further comprising an aeration system in fluid communication with the anaerobic reactor, wherein the aeration system is adapted to remove organic material from an effluent from the anaerobic reactor.

12. The apparatus of claim 10, further comprising an aeration system in fluid communication with the mixing zone, wherein the aeration system is adapted to remove organic material from an effluent from the anaerobic reactor.

13. The apparatus of claim 10, wherein the source of the magnesium hydroxide comprises a tank containing magnesium hydroxide and having an agitator adapted to maintain the magnesium hydroxide in a slurry.

14. The apparatus of claim 13, further comprising a pump mechanism adapted to pump the magnesium hydroxide out of the tank, through an inlet line, and into the mixing vessel.

15. The apparatus of claim 14, further comprising a pH meter configured to measure the pH of the neutralized wastewater effluent, and a dosing control mechanism adapted to control the amount of magnesium hydroxide introduced into the mixing vessel based upon the measured pH.

16. The apparatus of claim 14, further comprising a flushing mechanism adapted to flush the inlet line with water to remove magnesium hydroxide therefrom.
